(19) United States
(12) Patent Application Publication
(10) Pub. No.: US 2018/0300966 A1
(43) Pub. Date: Oct. 18, 2018

(54) Automatic Configuration of Telematic Data Transmissions of a Motor Vehicle

(71) Applicant: Bayerische Motoren Werke Aktiengesellschaft, Muenchen (DE)

(72) Inventors: Peter ZOLLER, Bad Feilnbach (DE); Christian CLAUSS, Planegg (DE)

(21) Appl. No.: 16/012,949

(22) Filed: Jun. 20, 2018

Related U.S. Application Data
(63) Continuation of application No. PCT/EP2016/080013, filed on Dec. 7, 2016.

(30) Foreign Application Priority Data
Dec. 21, 2015 (DE) 10 2015 226 147.6

(51) Int. Cl. G07C 5/00; H04L 12/24; H04L 29/08

(52) U.S. Cl. CPC G07C 5/008; H04L 67/125; H04L 41/0876

(57) ABSTRACT

A method for automatically configuring telematic data transmissions of a motor vehicle may include: selecting telematic data to be transmitted from the motor vehicle, creating a configuration profile for configuring a processor apparatus of the motor vehicle on a central computer in order to transmit the selected telematic data, transmitting the created configuration profile from the central computer to the processor apparatus, configuring the processor apparatus on the basis of the configuration profile in order to read in the selected telematic data, reading in the selected telematic data acquired by suitable sensors on the motor vehicle, and transmitting the telematic data which have been read in from the processor apparatus to at least one receiver via a radio connection.

### CROSS REFERENCE TO RELATED APPLICATIONS

This application is a continuation of PCT International Application No. PCT/EP2016/080013, filed Dec. 7, 2016, which claims priority under 35 U.S.C. § 119 from German Patent Application No. 10 2015 226 147.6, filed Dec. 21, 2015, the entire disclosures of which are herein expressly incorporated by reference.

### BACKGROUND AND SUMMARY OF THE INVENTION

The invention relates to a method, a processor apparatus, a motor vehicle having such a processor apparatus and a telematics system for automatically configuring telematic data transmissions of the motor vehicle.

DE 10 2012 009 554 A1 and DE 10 2013 015 737 A1 disclose methods for configuring a motor vehicle and devices present in the motor vehicle or units and/or Internet services used in a motor vehicle.

DE 101 41 539 A1 discloses a system for influencing functions of a motor vehicle. This system uses at least one telematics device with a transmitting and/or receiving unit on the motor vehicle and a remote central unit with a receiving and/or transmitting device, where the remote central unit can emit signals for remotely triggering vehicle functions and/or an identification signal to the telematics device and/or to a control unit of the motor vehicle.

DE 101 52 077 A1 and DE 10 2014 204 762 A1 disclose apparatuses and methods for capturing vehicle data via a wireless communication network and a telematics system for remotely controlling or influencing vehicle functions, where captured vehicle data can also be transmitted to other information providers of a third party provided that there is explicit customer consent.

The present invention is based on the object of providing a method, a processor apparatus and a motor vehicle having such a processor apparatus for automatically configuring, activating and deactivating telematic data transmissions of the motor vehicle, with the result that the telematic data transmission can be efficiently carried out and available transmission capacities and resources can be efficiently used.

Another object on which the invention is based is to provide a method, a processor apparatus and a motor vehicle having such a processor apparatus for automatically configuring telematic data transmissions of the motor vehicle, in which data security for transmitted telematic data is provided and is improved.

Yet another object on which the invention is based is also to provide a method, a processor apparatus and a motor vehicle having such a processor apparatus for automatically configuring telematic data transmissions of the motor vehicle, with the result that the automatic configuration can be carried out in a flexible and efficient manner.

A method for automatically configuring telematic data transmissions of a motor vehicle includes: selecting telematic data to be transmitted from the motor vehicle, creating a configuration profile for configuring a processor apparatus of the motor vehicle on a central computer in order to transmit the selected telematic data, transmitting the created configuration profile from the central computer to the processor apparatus, configuring the processor apparatus on the basis of the configuration profile in order to read in the selected telematic data, reading in the selected telematic data which are captured at the motor vehicle using suitable sensors, and transmitting the telematic data which have been read in from the processor apparatus to at least one receiver via a radio connection.

Creating the configuration profile on the central computer makes it possible to configure telematic data transmission of the motor vehicle in an automatic and flexible manner since the central computer has technical information relating to the respective motor vehicle and automatically creates the corresponding configuration profile matching the motor vehicle and its components.

Selecting particular telematic data, which are to be transmitted to the at least one receiver, results in the telematic data transmission being efficiently carried out and available transmission capacities and resources being efficiently used since only the selected telematic data are transmitted to the corresponding receiver of the telematic data.

Within the scope of the present invention, resources are understood as meaning equipment or system resources of a computer which are needed to operate the computer and to execute computer programs.

The at least one receiver of the telematic data may be the central computer, an operating computer for operating the central computer, and/or a receiver computer.

The telematic data from the motor vehicle include all data which are captured by sensors installed in the motor vehicle as well as sensor data which have been processed further and state information. Upon selecting the telematic data to be transmitted from the motor vehicle, these data are stipulated or defined as telematic data.

Within the scope of the present invention, the transmission of the configuration profile from the central computer to the motor vehicle also includes prior approval of a user for telematic data transmission to the receiver. This means, for example, that the receiver is authorized to receive the telematic data.

As a result of the authorization to receive the telematic data, data security is provided or the data security is improved since the respective user grants consent only to forward particular selected telematic data to this particular receiver. Telematic data which have not been selected cannot be transmitted and telematic data cannot be transmitted to an unauthorized receiver.

The central computer therefore makes it possible for configuration profiles to be able to be created without influence from the receiver, and for only the corresponding authorized user to be able to carry out a setting on the motor vehicle for the purpose of transmitting telematic data. As a result, data security is provided or the data security is improved.

Within the scope of the present invention, a user is understood as meaning an owner or a proprietor, a driver or an owner of the motor vehicle, or a person authorized by the owner.

The central computer can be a receiver of the telematic data and can be designed to transmit the received telematic data to a further receiver.

As a result of the central computer being provided for the purpose of receiving the telematic data and as a result of these telematic data being transmitted to a further receiver, these telematic data are not directly transmitted from the motor vehicle to a further receiver. The further receiver therefore has no direct access to the telematic data. As a result, data security is provided or the data security is improved. In addition, the telematic data can be buffered, combined and/or further processed on the central computer for subsequent transmission.

The telematic data can be transmitted only when a predetermined trigger condition is present. This makes it possible to efficiently transmit the telematic data and to efficiently use available transmission capacities and resources.

Within the scope of the present invention, the presence of a predetermined trigger condition includes the following states or their combinations: (i) expiry of a predetermined interval of time or immediate transmission, (ii) reaching of a predetermined time, date and/or day of the week, (iii) presence of new telematic data, (iv) reaching of a predetermined sensor value, a value of sensor data which have been processed further and/or an item of state information, (v) reaching of a predetermined volume of stored telematic data, (vi) access to a cost-effective and/or fast radio connection, and/or (vii) presence of a predetermined state of the motor vehicle and/or one of the receivers.

In this case, the predetermined trigger condition indicates a state in which it is possible, necessary and/or useful to transmit the telematic data. The trigger condition can be used to stipulate a transmission behavior for transmitting the telematic data. In this case, an individual trigger condition can be stipulated for each item of data of the telematic data or for each sensor value or sensor value which has been processed further.

Within the scope of the present invention, the predetermined state of the motor vehicle includes an operating state of the motor vehicle, for example, activation or deactivation. A fast radio connection is a radio connection which has a high transmission capacity. Telematic data can be buffered for delayed transmission of the telematic data, for example, after expiry of an interval of time. The telematic data which are transmitted upon reaching a predetermined volume of stored telematic data are the telematic data which are buffered in the motor vehicle and/or in the central computer.

The transmission of the telematic data can include retrieval of the telematic data by the at least one receiver.

Retrieving the telematic data makes it possible to use the receiver more efficiently. In this case, the receiver can automatically determine the time at which it would like to retrieve the telematic data.

The transmission of the telematic data can be controlled by messages, where such a message is a request to retrieve the telematic data.

As a result of the transmission of such a message which requests the retrieval of the telematic data, the motor vehicle can inform the at least one receiver of the telematic data and/or the central computer can inform the further receiver of the telematic data that new telematic data are available and can be retrieved. The respective receiver can then automatically determine the time at which it retrieves the telematic data. The telematic data transmission is therefore efficiently carried out and available transmission capacities and resources are efficiently used.

In order to retrieve the telematic data, the central computer can be designed to generate a security token for retrieving the telematic data. In this case, the receiver can be authenticated to retrieve the telematic data by the security token and/or the retrieval of the telematic data can be authorized by the security token.

As a result of the generation of a security token for retrieving the telematic data, the telematic data can be retrieved only when the potential receiver is authenticated and/or proves to be authorized to receive the telematic data by transmitting the security token. In addition, the security token can define the telematic data which can be retrieved. If the potential receiver cannot show a security token, no telematic data are transmitted to the receiver. As a result, data security is provided or the data security is improved.

Since only the central computer has the information needed to create the security token for the purpose of retrieving the telematic data from the respective motor vehicle or from itself, the central computer is the entity which generates the security token.

The security token may include a security certificate and/or a login name with a password and constitutes authentication data or authorization data in the sense of the invention.

An identification designator and/or motor-vehicle-specific parameters can be transmitted together with the telematic data when transmitting the telematic data. The identification designator identifies the motor vehicle, the user and/or a business process.

As a result of the transmission of the identification designator and/or the motor-vehicle-specific parameters, the receiver, to which the telematic data are transmitted, can uniquely assign the telematic data to the motor vehicle, the user and/or the business process.

Within the scope of the invention, a business process is understood as meaning an agreement related to the motor vehicle and/or the user, for example, a contractual agreement, such as an insurance contract.

The motor-vehicle-specific parameters include parameters which are stipulated and/or predetermined when producing the motor vehicle. These parameters are, for example, as vehicle identification designators for the respective motor vehicle for the purpose of identifying the vehicle, a vehicle identification number and/or a chassis number, a motor vehicle type or motor vehicle key number, a model designation, communication connection data for communicating with the motor vehicle, identification and/or version numbers of apparatuses, devices, units, software modules etc. present in the motor vehicle.

Within the scope of the present invention, the communication connection data are understood as meaning data which are needed to set up electronic communication and identify or address a communication receiver. The communication connection data include in this case network addresses, for example, IP addresses, resource locators, for example URLs, mobile radio identification numbers, telephone numbers and email addresses.

The selected telematic data can be repeatedly read in at the motor vehicle and/or the telematic data which have been read in can be repeatedly transmitted to the at least one receiver.

The process of repeatedly reading in and/or transmitting the telematic data makes it possible to consider and analyze the selected telematic data in a temporal profile, such as telematic data from the past can be concomitantly included in the analysis. In this case, it is possible, for example, to create a speed profile from speed data which have been repeatedly read in and transmitted. Such a speed profile can serve an insurance company, for example, as a basis for calculating an insurance premium.

Before or during transmission of the telematic data, these telematic data can be combined and only this combination can be transmitted.

Within the scope of the present invention, a combination of the telematic data is understood as meaning a combination in the form of a list, preprocessing, further processing, analysis, extraction, compression and/or encryption of these telematic data.

The preprocessing, further processing, analysis, extraction and/or compression allow(s) a considerable reduction in the telematic data to be transmitted, whereas the encryption enables or improves the data security when transmitting the telematic data to the receiver. A combination in the form of a list makes it possible to transmit the telematic data in blocks and possibly in a delayed manner.

The configuration profile can be created by dynamically combining predetermined configuration scripts. These configuration scripts can be accessed by the central computer. In this case, such a configuration script is designed to read in one or more of the motor-vehicle-specific parameters and/or to read in at least one sensor value from one or more sensors. In this case, the telematic data to be transmitted are formed by the at least one sensor value.

Dynamically combining predetermined configuration scripts for the purpose of creating the configuration profile results in the telematic data transmission being able to be configured in a flexible and efficient manner. In this case, a configuration script may be provided for each individual sensor parameter, identification designator and/or motor-vehicle-specific parameter or else for a plurality of these. As a result of these configuration scripts being dynamically combined, the central computer automatically generates the configuration profile which is transmitted to the motor vehicle.

In this case, the configuration scripts can be stored as predetermined templates on the central computer or in a storage device which is connected to the central computer. After the telematic data to be transmitted from the motor vehicle have been selected, the central computer first determines the type of motor vehicle and then reads in the corresponding configuration scripts of the selected telematic data for this motor vehicle type. The central computer can combine the configuration scripts which have been read in to form a configuration profile. As a result, the effort needed to create different configuration profiles for different vehicle types and different telematic data is kept as low as possible since only the individual configuration scripts, from which the configuration profile can be variably combined, have to be created in advance, and the telematic data transmission can be configured in a flexible and efficient manner.

If a configuration script for reading in and transmission is not available for a selected sensor value, identification designator and/or motor-vehicle-specific parameter, the configuration script can be created quickly and in an uncomplicated manner and can be made available to the central computer.

The transmission of the telematic data from the processor apparatus to the at least one receiver and/or from the central computer to a further receiver can be activated or blocked by a predetermined control message.

As a result, an activation or blocking process is simplified since only a short control message needs to be transmitted for such a process. In the event of blocking, the previously set configuration can be maintained in the motor vehicle or in the central computer, with the result that this configuration can be quickly activated again by a corresponding control message.

Another aspect of the present invention provides a processor apparatus for transmitting telematic data from a motor vehicle. In this case, the processor apparatus can be connected to a data bus of the motor vehicle via a data bus interface and/or can be connected to at least one sensor via at least one sensor interface for the purpose of reading in sensor values. If the data bus is provided for the purpose of reading in sensor values, the processor apparatus is connected to at least one control device in the motor vehicle via the data bus, and the at least one control device captures at least one sensor value by at least one sensor and outputs this at least one sensor value on the data bus. If the at least one sensor interface is provided for the purpose of reading in sensor values, the processor apparatus is connected to at least one sensor via the at least one sensor interface, and the at least one sensor outputs at least one sensor value via the at least one sensor interface. In this case, the at least one sensor value forms the telematic data to be transmitted. In this case, the processor apparatus can be connected to a radio device via a radio interface or via the data bus for the purpose of transmitting data, for example, for the purpose of transmitting the telematic data, and is designed to carry out the method explained above.

Another aspect of the present invention provides a motor vehicle including such a processor apparatus.

Another aspect of the present invention provides a telematics system including such a motor vehicle.

Furthermore, the telematics system may include a central computer for automatically configuring telematic data transmissions of the motor vehicle and an operating computer for operating the central computer.

The telematics system can be centrally controlled by the central computer, and all control data, for example, configuration scripts, configuration profiles, communication connection data, authentication data, authorization data, identification designators and/or motor-vehicle-specific parameters, can be centrally accessed on the central computer.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a telematics system for automatically configuring telematic data transmissions of a motor vehicle.

FIG. 2 illustrates a method for automatically configuring telematic data transmissions of a motor vehicle.

### DETAILED DESCRIPTION OF THE DRAWINGS

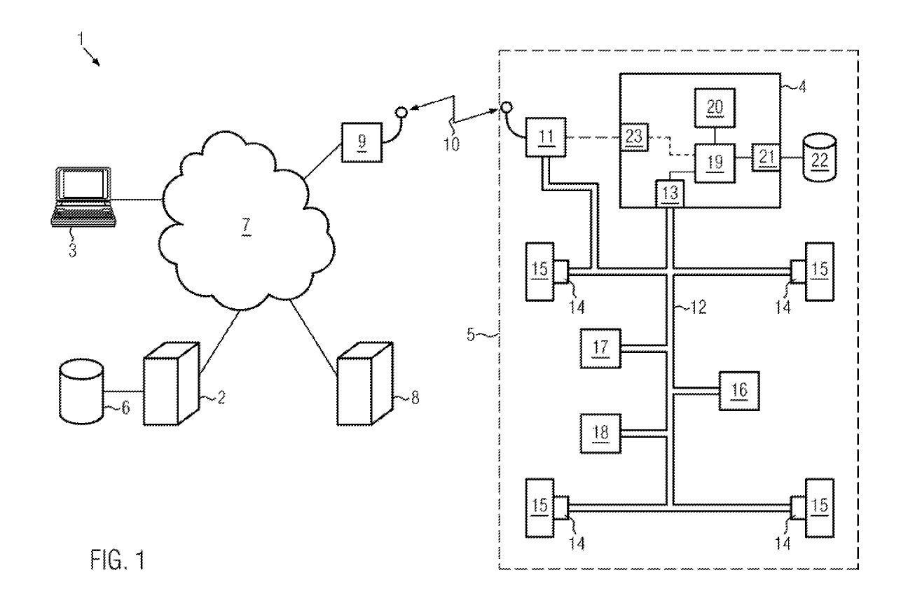

One embodiment of a telematics system 1 for automatically configuring telematic data transmissions of a motor vehicle is explained below (FIG. 1).

The telematics system 1 includes a central computer 2, an operating computer 3, a processor apparatus 4 of a motor vehicle 5, and the motor vehicle 5 has the processor apparatus 4.

The central computer 2 is used to automatically configure telematic data transmissions of the motor vehicle 5 and is used as the receiver for the telematic data from the motor vehicle 5. The central computer 2 is connected to a storage device 6 for storing data which are related to the performance of the method for automatically configuring telematic data transmissions of the motor vehicle 5. These data include configuration profiles, configuration scripts, identification designators for identifying the motor vehicle 5, a user and/or a business process, transmitted telematic data and their combinations, authentication data, authorization data and/or communication connection data for communication. These data are stored in a motor vehicle database provided that they are motor-vehicle-specific parameters.

The central computer 2 is connected to a data network 7. This data network 7 may be a local area data network (LAN) or a wide area network (WAN), for example, the Internet.

The operating computer 3 is likewise connected to the data network 7, with the result that it can communicate with the central computer 2. In this case, the operating computer 3 is used to operate the central computer 2, in which case an authentication process is carried out on the central computer 2 via the operating computer 3 so that only an authorized user of the operating computer 3 can operate the central computer 2.

A receiver computer 8 is also connected to the data network 7 and can communicate with the central computer 2 via the data network 7. In this case, the receiver computer 8 constitutes a further receiver of the transmitted telematic data, such as the central computer 2 can transmit or forward telematic data transmitted from the motor vehicle 5 to the receiver computer 8. In this case, an authentication or authorization process can be carried out so that only an authorized receiver computer 8 can communicate with the central computer 2 and can receive telematic data.

A stationary radio device 9 is also connected to the data network 7, with the result that the central computer 2 and the stationary radio device 9 can communicate with one another.

The stationary radio device 9 is connected to a radio device 11 arranged in the motor vehicle 5 by a radio connection 10. The radio device 11 is connected to a data bus 12 in the motor vehicle 5 and is designed to transmit data in a mobile radio system. In this case, the mobile radio system may be a system according to a mobile radio standard such as GSM, UMTS, LTE, 4G or 5G.

The processor apparatus 4 has a data bus interface 13. The processor apparatus 4 is connected to the data bus 12 via the data bus interface 13, with the result that the control computer 2 and the processor apparatus 4 can communicate with one another via the components explained above.

The data bus 12 connects further apparatuses or devices of the motor vehicle 5 to one another and to the processor apparatus 4. These apparatuses and devices of the motor vehicle 5 can communicate with one another and with the processor apparatus 4 via the data bus 12.

Sensors of the motor vehicle 5 which are coupled to the data bus 12 can therefore transmit messages containing sensor values to the processor apparatus 4.

However, the processor apparatus 4 can also listen to or record the data traffic via the data bus 12, when transmitting messages having sensor data to other receivers coupled to the data bus 12 via the data bus 12, in order to concomitantly read these messages. As a result, the processor apparatus 4 can easily read in sensor values or extract them from a message.

Within the scope of the invention, a sensor value is also understood as meaning a value which can be determined by processing sensor values further. For example, the speed, cornering speed and acceleration of the motor vehicle 5 can be determined from wheel speed values by processing these wheel speed values further. The processor apparatus 4 can therefore also receive messages containing sensor values which have been processed further via the data bus 12 and can read in sensor values which have been processed further by concomitantly reading messages on the data bus 12 or can extract them from the messages which have been concomitantly read.

The further apparatuses and devices connected via the data bus 12 are explained below.

Wheel speed sensors 14 which are coupled to wheels 15 of the motor vehicle 5 are connected to the data bus 12. These wheel speed sensors 14 determine a speed of the respective wheel 15 as a sensor value and provide this sensor value in the form of a message on the data bus 12.

A central control device 16 for controlling components of the motor vehicle 5 is connected to the data bus 12. The central control device 16 receives messages which are generated by the wheel speed sensors 14 and can contain the wheel speeds measured by the wheel speed sensors 14 as sensor values. The central control device 16 processes these sensor data in order to calculate the speed of the motor vehicle 5 and transmits a message containing the calculated vehicle speed, via the data bus 12, to a tachometer 17 connected to the data bus 12.

The vehicle speed is then displayed on the tachometer 17, with the result that a driver of the motor vehicle 5 can read this speed.

The message for the tachometer 17 with the vehicle speed contained therein can be concomitantly read by the processor apparatus 4, as a result of which the processor apparatus 4 can extract the vehicle speed from the message.

A navigation system 18, for example, a system according to the global positioning system (GPS) standard, is also connected to the data bus 12. The navigation system 18 can likewise provide speed data via the data bus 12. The navigation system 18 can also output an error message on the data bus 12, which message indicates whether the motor vehicle 5 is parked in a garage or an underground parking garage. This is because the reception of a satellite signal, as is used for navigation in the GPS system or other navigation systems, is possible only to a restricted extent or is not possible at all in a garage. In this respect, the absence of the reception of such a satellite signal for a relatively long time in conjunction with a vehicle speed which indicates that the motor vehicle 5 is stationary indicates that the vehicle is parked in a garage.

The processor apparatus 4 can therefore detect that the motor vehicle 5 is in a garage by extracting the speed of the motor vehicle 5, as explained above, and extracting error messages from the navigation system 18.

Further components of the processor apparatus 4 are explained below.

A microprocessor 19 which controls the processor apparatus 4 is connected to the data bus interface 13. The microprocessor 19 can communicate with the data bus 12 via the data bus interface 13 and can concomitantly read and extract messages which are transmitted via the data bus 12.

The microprocessor 19 is also connected to an internal memory 20. This internal memory 20 is used to store programs which can be executed by the microprocessor 19 and are executed during operation of the processor apparatus 4 as well as further data during operation of the processor apparatus 4.

The microprocessor 19 is also connected to a storage device interface 21, to which an external storage device 22 is coupled. The microprocessor 19 can write data to the external storage device 22 and can read data from the latter via the storage device interface 21. This serves to make it possible to use storage media which are as favorable as possible to store data, for example, if large volumes of telematic data are stored. The external storage device 22 is in the form of a persistent memory so that the data are not lost even if the power supply is switched off or disrupted. The external storage device 22 is, for example, a drive which has flash memories for storage.

Motor-vehicle-specific parameters, communication connection data, authentication data, authorization data, sensor data, their combinations and/or telematic data can be stored in the internal memory 20 and/or in the external storage device 22.

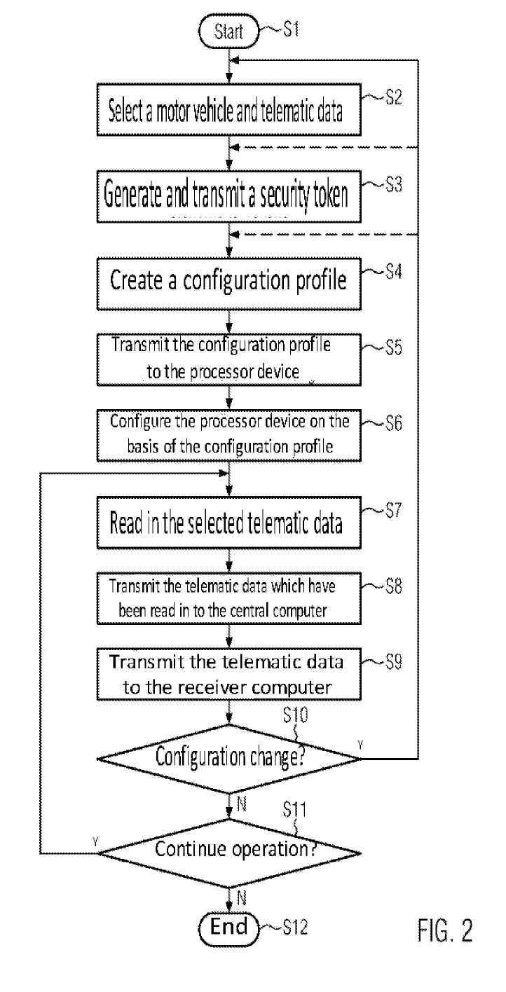

Another embodiment of a method for automatically configuring telematic data transmissions of a motor vehicle is explained below (FIG. 2). This method can be carried out using the telematics system 1 explained above. This embodiment is explained on the basis of an insurance contract which is concluded between an insurance company and the owner of the motor vehicle 5 and the insurance premiums of which need to be adapted or calculated.

The method begins in step S1.

In step S2, a motor vehicle 5 and telematic data to be transmitted from the latter are selected on the operating computer 3. The selection of the telematic data presupposes a previous login of the user of the operating computer 3 on the central computer 2 with successful authentication and identification of the corresponding motor vehicle 5. In this case, a vehicle identification designator, for example, a vehicle identification number or a chassis number, can be input for the motor vehicle 5. The data which have been input are transmitted to the central computer 2 and can be stored in the storage device 6 for subsequent use. On the basis of the vehicle identification designator, the central computer 2 can determine the vehicle type and communication connection data for communicating with the motor vehicle 5 from the motor vehicle database stored in the storage device 6. These communication connection data are, for example, a mobile radio call number of the radio device 11.

The central computer 2 controls the display of the operating computer 3 in such a manner that only telematic data whose sensor values are accordingly available in the motor vehicle 5 or can be determined from sensor values available in the motor vehicle 5 are offered for selection. For example, speed data and location data relating to the motor vehicle 5 are displayed on the operating computer 3 as telematic data which can be selected if the vehicle type of the motor vehicle 5 has a data bus 12 with a tachometer 17 and a navigation system 18 connected thereto.

The central computer 2 also controls the display of the operating computer 3 in such a manner that the user can select or input, for selected telematic data, a trigger condition or a combination of trigger conditions for transmitting the telematic data. Such a predetermined trigger condition is explained above.

With the selection of the telematic data to be transmitted, the user grants his consent or authorizes the reception of the telematic data from the motor vehicle 5.

The central computer 2 then generates a security token for retrieving the telematic data from the central computer 2 (step S3). The central computer 2 generates the security token only if the user's consent to receive the telematic data from the motor vehicle 5 is available. The retrieval of the telematic data is allowed or possible only by transmitting the security token. This means that the receiver is authenticated with transmission of the security token and the retrieval of the telematic data is therefore authorized. The central computer 2 transmits this security token to the operating computer 3, possibly together with previously selected trigger conditions, the communication connection data relating to the central computer 2 and/or authentication data. The user of the operating computer 3 then forwards the security token to the receiver computer 8, for example, together with the predetermined trigger condition, the communication connection data relating to the central computer 2 and/or the authentication data. The receiver computer 8 may be, for example, a computer belonging to the insurance company with which the motor vehicle 5 is insured.

In the subsequent step S4, the central computer 2 automatically creates a configuration profile for configuring the processor apparatus 4 on the basis of the telematic data selected in step S2 in order to transmit the selected telematic data from the motor vehicle 5. In this case, the configuration profile is created by combining configuration scripts which are suitable for the motor vehicle type and are stored as predetermined templates in the storage device 6. For example, a configuration script for reading in the speed and a configuration script for reading in location data are combined with one another. The respective predetermined trigger conditions can be entered in the configuration profile for the corresponding telematic data by the central computer 2.

This configuration profile is then transmitted from the central computer 2 to the processor apparatus 4 (step S5) by virtue of the stationary radio device 9 being instructed by the central computer 2 to set up the radio connection 10 to the radio device 11 on the basis of the communication connection data relating to the motor vehicle 5. The configuration profile is then transmitted from the central computer 2, via this radio connection 10, to the radio device 11 and is forwarded from the latter to the processor apparatus 4 via the data bus 12. Authentication data and/or authorization data, which prove that the central computer 2 is authorized to configure and receive the telematic data, and communication connection data relating to the central computer 2 for transmitting the telematic data are transmitted together with the configuration profile.

The processor apparatus 4 is configured, on the basis of the transmitted configuration profile, to read in the selected telematic data from the data bus 12 (step S6). For example, the telematic data are the speed and the location of the motor vehicle 5. The processor apparatus 4 checks, on the basis of the authentication data and/or authorization data, whether the central computer 2 is authorized to configure the processor apparatus 4 before configuration. Transmitted trigger conditions for transmitting the telematic data are buffered and configured by the processor apparatus 4.

The processor apparatus 4 then reads in the selected telematic data from the data bus 12 by concomitantly reading messages on the data bus 12 and extracting the selected telematic data therefrom (step S7). For example, the processor apparatus 4 extracts the speed of the motor vehicle 5 from messages transmitted by the central control device 16 to the tachometer 17 and extracts the location of the motor vehicle 5 or a reception state of satellite signals from messages which are output on the data bus 12 by the navigation system 18. The speed and the associated location can be stored in a manner linked to one another in the internal memory 20 and/or in the external storage device 22 for subsequent combination and/or transmission, for example, taking into account the trigger conditions for transmitting the telematic data.

According to the trigger conditions for transmitting the telematic data, the processor apparatus 4 transmits the telematic data which have been read in to the central computer 2 by outputting them, together with the communication connection data relating to the central computer 2, to the radio device 11 via the data bus 12 (step S8). The radio device 11 transmits the telematic data to the stationary radio device 9 which then forwards these telematic data to the central computer 2. If, for example, a corresponding trigger condition for transmitting the telematic data has been set, the telematic data are transmitted at predetermined intervals of time as a combination in order to only slightly load the transmission capacity of the radio devices 9, 11 or of the mobile radio system and of the data network 7. Authentication data and/or authorization data, which prove that the processor apparatus 4 is authorized to transmit the telematic data, can be additionally transmitted to the central computer 2 with the telematic data.

On the basis of the communication connection data transmitted by the operating computer 3, the receiver computer 8 is connected to the central computer 2 taking into account the trigger conditions for transmitting the telematic data (step S9). In this case, an authentication process takes place by the previously transmitted security token by virtue of the latter being transmitted from the receiver computer 8 to the central computer 2. The central computer 2 identifies the receiver computer 8 as authorized to retrieve the telematic data by the received security token. The receiver computer 8 then retrieves the telematic data transmitted from the processor apparatus 4 to the central computer 2 from the central computer 2. For example, the receiver computer 8 belonging to the insurance company retrieves the speed, linked to the location of the motor vehicle 5, as telematic data, with the result that these telematic data are transmitted from the central computer 2 to the receiver computer 8. A road-based speed profile of the motor vehicle 5 can be determined from these telematic data, in which case it can be determined whether the driver of the motor vehicle 5 has complied with or has violated any speed restrictions. It can likewise be determined whether the motor vehicle 5 has been parked in a garage. This information can serve the insurance company to adapt an insurance premium for the owner.

In the subsequent step S10, the central computer 2 checks whether a configuration needs to be changed, such as a check is carried out in order to determine whether a user of the operating computer 3 has logged onto the central computer 2 in order to change the telematic data to be captured and/or the receiver for the motor vehicle.

If this is the case, step S2 is carried out again. However, if there is no configuration change in step S10, the method sequence is continued with the execution of step S11 in which it is determined whether operation is to be continued.

If operation is to be continued, the processor apparatus 4 carries out step S7 again. Otherwise, the method ends in step S12.

Alternative embodiments of the telematics system 1 are explained below. Alternative components and connections are shown using dashed lines in FIG. 1.

The operating computer 3 can be identical to the receiver computer 8. As a result, a user can retrieve telematic data relating to his motor vehicle 5.

The processor apparatus 4 may have a direct connection to the radio device 11 via a radio interface 23, and the connection between the radio device 11 and the data bus 12 can be omitted. In this case, the processor apparatus 4 can exclusively use the radio device 11. This makes it possible to improve the data transmission security since other apparatuses and devices of the motor vehicle 5 do not have access to the radio device 11 and the transmission capacity of the radio device 11 is available solely for the transmission of the telematic data.

If the radio device 11 is directly connected to the processor apparatus 4 and the radio device 11 does not have a connection to the data bus 12, the radio device 11 can be integrated in the processor apparatus 4. As a result, the processor apparatus 4 may also be in the form of a module for subsequent coupling to the data bus 12. The integration of the radio device 11 also makes the use of the processor apparatus 4 independent of the presence of a radio device 11 on the motor vehicle, for example, the processor apparatus 4 can be used as intended even if the motor vehicle 5 does not have a radio device 11. Coupling to the data bus 12 can then be carried out using a suitable interface on the motor vehicle 5. One example of such an interface is a diagnostic interface, such as an OBD (on-board diagnosis) interface.

The substeps of the method which are carried out by the processor apparatus 4 can be alternatively carried out by the central control device 16. This means that the processor apparatus 4 can be identical to the central control device 16 of the motor vehicle 5. As a result, a central control device 16 which is provided in modern motor vehicles 5 anyway can be used to transmit the telematic data. However, computing power and available resources of the central control device 16 are loaded thereby and a design as a module which can be subsequently coupled is dispensed with.

The external storage device 22 can also be omitted. In this case, the storage device interface 21 can be additionally omitted. All data needed to operate the processor apparatus 4 can then be stored in the internal memory 20. The internal memory 20 is then in the form of a persistent memory so that the data are not lost even if the power supply is switched off or disrupted.

The wheel speed sensors 14, the tachometer 17 and/or the navigation system 18 can also be omitted. Only at least one sensor which captures sensor values which form the telematic data must be present on the motor vehicle 5.

As an alternative or in addition to the wheel speed sensors 14, the tachometer 17 and/or the navigation system 18, other sensors present on the motor vehicle 5 may also be coupled to the data bus 12, with the result that the processor apparatus 4 can read in their sensor values. For example, sensors other than the wheel speed sensors 14 for capturing a speed of the motor vehicle 5 and/or sensors for capturing an engine speed of a drive of the motor vehicle 5, transmission settings, acceleration values, gas pedal and/or brake pedal positions, location information, date/time/day of the week and/or weather data, such as outside temperature, amount of precipitation, air pressure and/or humidity and/or (side) wind strength, may be provided on the motor vehicle 5 and their sensor data may be transmitted as telematic data. The telematic data may also include sensor data which have been processed further, such as mileage or route information.

The telematic data may also include state data relating to the motor vehicle 5, such as service intervals and times, and state data relating to components of the motor vehicle 5.

Values of the captured telematic data may also be used as a trigger condition for transmitting the telematic data.

Alternative embodiments of the above-described method for automatically configuring telematic data transmissions of a motor vehicle are explained below.

The order in which steps S3, S4, S5 and S6 are carried out can be changed as follows: S4, S3, S5, S6 or S4, S5, S3, S6 or S4, S5, S6, S3, or any other suitable order.

In step S3, the central computer 2 can also generate a security token, with which it can be authenticated in the motor vehicle 5 for the purpose of retrieving the telematic data or with which it can be itself authorized to retrieve the telematic data with respect to the motor vehicle 5.

Step S3 can also be omitted or skipped. A security token for retrieving the telematic data is then not generated.

During the selection of the telematic data to be captured by the user in step S2 and/or during the creation of the configuration profile by the central computer 2 in step S4, the manner in which the captured telematic data are combined can be additionally stipulated, individually for the respective telematic data. This manner of combination is then concomitantly taken into account by the central computer 2 in step S4 when creating the configuration profile and is stored in the configuration profile and/or on the central computer 2. The manner of combination is then concomitantly taken into account in step S8 and/or S9 when transmitting the telematic data. This makes it possible to efficiently use available transmission capacities and resources.

Step S8 can also be omitted or skipped. The telematic data are then directly transmitted from the motor vehicle 5 to the receiver computer 8 in step S9.

The execution of step S8 and/or S9 can be delayed or the execution of steps S8 and S9 or S8, S9 and S10 can be omitted or these steps can be skipped, for example, if there is no radio connection 10 to the central computer 2 or the telematic data are intended to be transmitted in blocks as a combination. The telematic data to be transmitted are buffered in these cases in the internal memory 20, in the external storage device 22 and/or in the storage device 6. If there is a radio connection 10 to the central computer 2 again and/or if combined telematic data are intended to be transmitted, the buffered data can then be transmitted to the central computer 2 and/or to the receiver computer 8.

Before transmitting the telematic data to the central computer 2 in step S8, the processor apparatus 4 can combine the telematic data.

The central computer 2 can likewise combine the telematic data in step S9 before transmitting the telematic data to the receiver computer 8.

As an alternative to transmitting the telematic data in step S9, a message containing a request to retrieve the telematic data from the central computer 2 can also be transmitted to the receiver computer 8. In response to the message, the receiver computer 8 can then automatically retrieve the telematic data at the central computer 2, also with a time delay. In order to transmit the message, the user transfers the communication connection data relating to the receiver computer 8 to the central computer 2 in step S2.

The retrieval of the telematic data from the central computer 2 by the receiver computer 8 in step S9 can be carried out on the basis of a system load of the receiver computer 8.

In step S9, the central computer 2 can also actively transmit the telematic data to the receiver computer 8. In order to transmit the telematic data, the user transfers the communication connection data relating to the receiver computer 8 to the central computer 2 in step S2.

If it is determined in step S8 or in step S9 that sufficient transmission capacities or resources are not available for transmitting the telematic data and/or that an error occurs when transmitting the telematic data, the central computer 2 can initiate an automatic configuration change in step S10. In these cases, either of steps S3 and S4 is carried out after carrying out step S10, depending on the requirement. This is shown using dashed lines in FIG. 2. In step S3, the central computer 2 can generate another security token which is transmitted by the central computer to the operating computer 3. The operating computer 3 can then transmit this security token, possibly together with previously selected trigger conditions, the communication connection data relating to the central computer 2 and/or authentication data, to another receiver computer 8. The other receiver computer 8 can then retrieve the telematic data in step S9. In step S4, the central computer 2 can create another configuration profile. In step S4, the central computer 2 can stipulate another manner in which the telematic data are combined and can stipulate other trigger conditions for transmitting the telematic data. By way of the automatic configuration change, available transmission capacities and resources can be efficiently used and the transmission can be enabled despite an error which has occurred.

Thus, the security token can be effected once during registration of a receiver of telematic data for retrieving telematic data intended for this receiver. The receiver is then authenticated by transmitting the security token and is consequently authenticated and/or indicates that it is authorized to retrieve telematic data by transmitting the security token. The telematic data retrieved during such a process may include in this case telematic data from a motor vehicle 5 or else telematic data from a plurality of motor vehicles 5. For example, the receiver computer 8 can be authenticated in the central computer 2 by transmitting a security token and can then successively retrieve the telematic data intended for it from a plurality of motor vehicles 5 before the receiver computer 8 logs off from the central computer 2 again. In this case, the authorization to retrieve the telematic data from the respective motor vehicle 5 is effected by the previously granted consent from the user of the corresponding motor vehicle 5, which consent is stored on the central computer 2.

Additionally or alternatively, provision may be made for the central computer 2 and/or the receiver computer 8 to transmit a message to the motor vehicle 5 in the form of a request to retrieve telematic data. The receiver computer 8 can transmit this message directly to the motor vehicle 5 or via the central computer 2 or can request the central computer 2 to transmit the message to the motor vehicle 5. The transmitted message is then displayed by the processor apparatus 4 on a display device (not shown) connected to it. The driver or an occupant of the motor vehicle 5 can then approve or reject the request to retrieve the telematic data by making a corresponding input on an input device (not shown) connected to the processor apparatus 4 in the motor vehicle 5. This input is then transmitted from the processor apparatus 4 to the central computer 2 or to the receiver computer 8. If the request to retrieve the telematic data is approved by the driver or an occupant, the retrieval of data is enabled and the authorization to retrieve the telematic data is given. For example, this procedure is advantageous if the user of the operating computer 3 and the driver or each of the occupants of the motor vehicle 5 are not the same person, for example, if the motor vehicle 5 is a rental vehicle or a company vehicle belonging to a company.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SYMBOLS

1 Telematics system
2 Central computer
3 Operating computer
4 Processor apparatus
5 Motor vehicle
6 Storage device
7 Data network
8 Receiver computer
9 Stationary radio device
10 Radio connection
11 Radio device
12 Data bus
13 Data bus interface
14 Wheel speed sensor
15 Wheel
16 Control device
17 Tachometer
18 Navigation system
19 Microprocessor
20 Internal memory
21 Storage device interface
22 External storage device
23 Radio interface

What is claimed is:

1. A method for automatically configuring telematic data transmissions of a motor vehicle, the method comprising the acts of:
selecting telematic data to be transmitted from the motor vehicle;
creating a configuration profile for configuring a processor apparatus of the motor vehicle on a central computer in order to transmit the selected telematic data;
transmitting the created configuration profile from the central computer to the processor apparatus;
configuring the processor apparatus based on the configuration profile in order to read in the selected telematic data;
reading in the selected telematic data captured at the motor vehicle via one or more sensors; and
transmitting the telematic data read in from the processor apparatus to at least one receiver via a radio connection.

2. The method according to claim 1, wherein the central computer is a receiver of the telematic data and is configured to transmit the received telematic data to a further receiver.

3. The method according to claim 1, wherein the telematic data is transmitted only when a predetermined trigger condition is present.

4. The method according to claim 1, wherein the transmitting of the telematic data includes retrieving the telematic data by the at least one receiver.

5. The method according to claim 1, wherein the transmitting of the telematic data is controlled by one or more messages, wherein a message of the one or more messages is a request to retrieve the telematic data.

6. The method according to claim 4, wherein the central computer is configured to generate a security token for retrieving the telematic data, wherein the at least one receiver is authenticated to retrieve the telematic data by the security token and/or the retrieval of the telematic data is authorized by the security token.

7. The method according to claim 1, wherein an identification designator that identifies the motor vehicle, a user and/or a business process, and/or motor-vehicle-specific parameters is transmitted together with the telematic data when transmitting the telematic data.

8. The method according to claim 1, wherein the selected telematic data is repeatedly read in at the motor vehicle and/or the telematic data which has been read in is repeatedly transmitted to the at least one receiver.

9. The method according to claim 1, wherein before or during the transmitting of the telematic data, the telematic data is combined and only the combination is transmitted.

10. The method according to claim 1, wherein the configuration profile is created by dynamically combining at least one predetermined configuration script accessible by the central computer, wherein the at least one configuration script reads in one or more of the motor-vehicle-specific parameters and/or reads in at least one sensor value from the one or more sensors, and wherein the at least one sensor value forms the telematic data to be transmitted.

11. The method according to claim 1, wherein the transmitting of the telematic data from the processor apparatus to the at least one receiver and/or from the central computer to a further receiver is activated or blocked by a predetermined control message.

12. A processor apparatus for transmitting telematic data from a motor vehicle,
wherein the processor apparatus is connectable to a data bus of the motor vehicle via a data bus interface and/or is connectable to at least one sensor via at least one sensor interface for reading in one or more sensor values, and
the processor apparatus is:
connected to at least one control device in the motor vehicle via the data bus if the data bus is provided for the purpose of reading in the one or more sensor values, and the at least one control device captures at least one sensor value via at least one sensor and outputs the sensor value to the data bus, and
connected to at least one sensor via the at least one sensor interface if the at least one sensor interface is provided for the purpose of reading in the one or more sensor values, and the at least one sensor outputs at least one sensor value via the at least one sensor interface,
wherein the at least one sensor value forms the telematic data to be transmitted, and
wherein the processor apparatus is connectable to a radio device via a radio interface or via the data bus for transmitting data.

13. A motor vehicle comprising the processor apparatus according to claim 12.

14. A telematics system comprising a motor vehicle according to claim 13.

15. The telematics system according to claim 14, wherein the telematics system comprises: a central computer for automatically configuring telematic data transmissions of the motor vehicle and an operating computer for operating the central computer.

16. The processor apparatus according to claim 12, wherein the data is telematic data.

17. The processor apparatus according to claim 12, wherein the processor apparatus is configured to perform the method according to claim 1.
